(19) United States
(12) Patent Application Publication
(10) Pub. No.: US 2015/0135542 A1
(43) Pub. Date: May 21, 2015

(54) FEEDBACK SYSTEM FOR BAR CLAMPING

(71) Applicant: Trent Cook, Anderson, SC (US)

(72) Inventor: Trent Cook, Anderson, SC (US)

(73) Assignee: Husqvarna AB, Huskvarna (SE)

(21) Appl. No.: 14/405,479

(22) PCT Filed: Jun. 6, 2012
(86) PCT No.: PCT/US12/41009

§ 371 Date: Dec. 4, 2014

(51) Int. Cl. B27B 17/14; F16D 7/02; G05G 5/03

(52) U.S. Cl. CPC B27B 17/14; G05G 5/03; F16D 7/024
USPC 30/386; 74/471 R; 464/46; 464/36; 464/38

(57) ABSTRACT

A knob sub assembly for adjusting bar clamp tension holding a chainsaw bar of a chainsaw to a chainsaw body of the chainsaw may include a cap, a nut and a feedback assembly. The nut may be threaded to facilitate engagement with a fixing post of the chainsaw body responsive to a transfer of torque from the cap to the nut when the cap is rotated by an operator. The feedback assembly may be disposed substantially between the cap and the nut to at least selectively transfer torque from the cap to the nut. The feedback assembly may provide feedback to the operator when a predetermined threshold of applied torque is reached.

### TECHNICAL FIELD

Example embodiments generally relate to chainsaws and, more particularly, relate to a chainsaw having a feedback system incorporated to inform the operator when proper torque has been applied with respect to affixing a chainsaw bar.

### BACKGROUND

Chainsaws are commonly sold in one of various different conditions. First, the chainsaw may be sold completely assembled with the bar already attached, and the chain installed on the bar and properly connected to the clutch. Selling chainsaws in this manner supplies a chainsaw already fully and correctly assembled, but requires additional assembly time and corresponding expense. A second common condition in which chainsaws are sold is with the bar and chain not yet assembled. For example, the bar and chain may be placed in the box or packaging in which the chainsaw is sold separately from each other and the chainsaw body. As yet another alternative, the chain may be placed over the bar, but the entire assembly may be placed into a loose fitting packaging container. The buyer may then be expected to install the chain onto the bar, and install the bar and chain combination onto the chainsaw, or at least maintain the chain properly on the bar while installing the bar and chain combination onto the chainsaw.

Installing the bar and chain onto the chainsaw may be a relatively simple task for experienced chainsaw owners. However, for many first time or relatively inexperienced buyers, installation of the bar and chain may be a bit more tricky. For example, it is possible to install the chain backwardly on the bar. Backward installation of the chain will not properly dispose the cutters on the chain toward the lumber to be cut, and thus cutting efficiency could be vastly reduced. Furthermore, even when the chain is correctly oriented on the bar, it may be difficult to install the bar/chain combination onto the chainsaw and properly connect the chain to the clutch. These difficulties and corresponding buyer complaints may lead many manufacturers to take the extra step and costs associated with completing assembly. However, shipping costs may also be increased due to the larger size of the resulting packaging needed for shipment of a fully assembled chainsaw. Moreover, bar/chain replacement may also be just as difficult for chainsaw users to handle themselves. Thus, full assembly may not be a completely satisfying option. Furthermore, maintenance activities and routine operation may require the operator to make adjustments in order to ensure the chain and/or the chainsaw bar are properly assembled and tensioned.

There are currently two primary categories into which fastening systems for affixing the chainsaw bar to the power head fall. The first of these categories includes systems that require the use of tools to fasten the bar to the chainsaw. Although the tools may be relatively common wrenches or other tightening tools, many operators may be bothered by continually having to find tools or at least keep them handy when using the chainsaw. Accordingly, the second category has been developed to avoid the need for separate tools. The second category, which is a tool-less system, enables the bar to be affixed to the power head without separate tools. However, with either of these fastening methods, it may be difficult for the operator to know or appreciate when the bar has been properly tightened to the chainsaw. Over tightening or under tightening may therefore be possible.

### BRIEF SUMMARY OF SOME EXAMPLES

Some example embodiments may provide a feedback mechanism for informing a chainsaw operator that the bar tensioning mechanism has been properly tensioned. Moreover, some embodiments may enable the provision of such feedback in connection with a bar tightening system that is easy to operate without using any tools. The feedback mechanism may be incorporated into components of a cover portion which in turn is attached to a chainsaw body. A guide bar may be secured between the cover portion and the chainsaw body and the feedback mechanism may inform the operator of the fact that the tension being applied to the guide bar is within a predetermined range. Moreover, in some cases, the feedback mechanism may also prevent the further application of torque once the guide bar tension is within the predetermined range. Accordingly, some embodiments may solve or at least reduce the problems discussed above. In particular, some embodiments may provide a chainsaw having a clamping device providing a relatively simple feedback mechanism. In some embodiments, the feedback mechanism, which provides for proper application of torque to the guide bar, may be provided on the same assembly that also assists with chain tensioning.

In one example embodiment, a chainsaw is provided. The chainsaw includes a chainsaw body, a chainsaw bar configured to be operably coupled to a cutting chain, and a cover disposed proximate to a portion of the chainsaw bar to facilitate clamping the chainsaw bar to the chainsaw body. The cover may be configured to receive a knob sub assembly. The knob sub assembly may include a cap, a nut and a feedback assembly. The nut may be threaded to facilitate engagement with a fixing post of the chainsaw body responsive to a transfer of torque from the cap to the nut when the cap is rotated by an operator. The feedback assembly may be disposed substantially between the cap and the nut to at least selectively transfer torque from the cap to the nut. The feedback assembly may provide feedback to the operator when a predetermined threshold of applied torque is reached.

In another example embodiment, a knob sub assembly for adjusting bar clamp tension holding a chainsaw bar of a chainsaw to a chainsaw body of the chainsaw is provided. The knob sub assembly may include a cap, a nut and a feedback assembly. The nut may be threaded to facilitate engagement with a fixing post of the chainsaw body responsive to a transfer of torque from the cap to the nut when the cap is rotated by an operator. The feedback assembly may be disposed substantially between the cap and the nut to at least selectively transfer torque from the cap to the nut. The feedback assembly may provide feedback to the operator when a predetermined threshold of applied torque is reached.

Some example embodiments may provide an operator with a relatively easy way to tighten the bar to a reliably consistent torque without tools.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a perspective view of a chainsaw according to an example embodiment;

FIG. 2 illustrates a perspective view of another chainsaw according to an example embodiment;

FIG. 3 illustrates a perspective view of a combination tension and clamping assembly, which includes the knob sub assembly that is withdrawn from the drive sprocket cover of a chainsaw according to an example embodiment;

FIG. 4 illustrates an exploded perspective view of some portions of the tension and clamping assembly according to an example embodiment;

FIG. 5 illustrates a side view of a body portion of a chainsaw with drive sprocket cover removed according to an example embodiment;

FIG. 6 is an exploded view of the knob sub assembly according to an example embodiment;

FIG. 7 is a cross sectional view of the knob sub assembly according to an example embodiment;

FIG. 8 illustrates an exploded perspective view of a feedback assembly that employs an inclined ramp assembly according to an example embodiment;

FIG. 9 illustrates a cross sectional view of the feedback assembly of FIG. 8 according to an example embodiment;

FIG. 10 illustrates a top perspective view of a cap that employs a locking lever according to an example embodiment;

FIG. 11 illustrates a cross sectional view of a knob sub assembly employing the locking lever according to an example embodiment; and

FIG. 12, which includes FIGS. 12A and 12B, shows a side view of two example inclined ramp embodiments disposed within a corresponding depression according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments described herein provide a bar clamping mechanism that provides feedback to the operator when the bar is clamped to within a specified range or at least above a predetermined threshold. Moreover, some embodiments may also prevent the application of additional torque after the specified range or predetermined threshold is reached. The bar clamping mechanism of some example embodiments may be structured for tool-less operation. In some cases, the bar clamping mechanism may also be provided in combination with a chain tensioning mechanism using a single knob, where the knob has two modes of operation. The mode shift may shift between the first mode of operation in which chain tension is adjustable and the second mode of operation in which bar clamping tension is adjustable. Thus, for example, some embodiments may enable use of a single implement (e.g., the knob) for chain tightening to a particular threshold until a mode shift occurs and then bar clamping to the predetermined threshold until the feedback mechanism informs the operator that the bar is properly clamped.

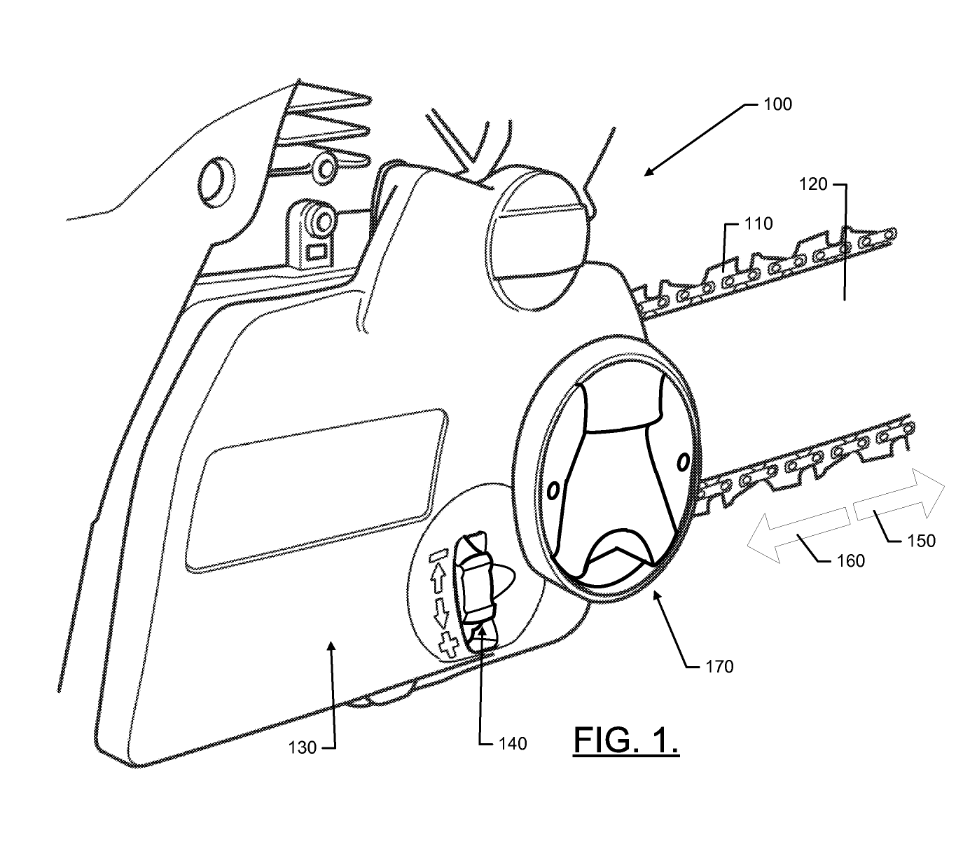

Referring now to FIG. 1, a chainsaw 100 is shown fully assembled in order to facilitate a description of some portions of the chainsaw 100 that are applicable to interaction with an example embodiment. Among other things, the chainsaw 100 may include a drive member or drive sprocket that is rotated responsive to operation of the engine of the chainsaw 100. The drive sprocket may be operably connected to a saw chain 110, which may include cutters disposed on all or some of a series of chain links that are interconnected to form a continuous flexible chain. Some or all of the chain links may include engagement teeth that are configured to fit within and slidably engage a guide slot that extends around a periphery of a bar 120 (e.g., a chainsaw bar or guide bar) that is operably coupled to the chainsaw 100.

In some embodiments, the drive sprocket (or drive member) may be embodied as a part of a clutch (not shown in FIG. 1) that is disengaged when the engine idles, but engages to rotate the chain 110 around the bar 120 (e.g., via the engagement teeth sliding through the guide slot) when the engine throttle is opened. In chainsaws that are electrically powered, there may be no need for a clutch, since an electric motor may power the drive sprocket and the electric motor need not idle when rotation of the chain is not desired. Thus, instead of including a clutch, the electric motor may be engaged to drive the drive sprocket whenever a trigger or throttle lever is depressed to activate the electric motor and may simply be disengaged at other times.

The bar 120 may be a unitary, substantially flat metallic member that is elongated to form a substantially oblong blade. However, in some embodiments, the bar 120 may not necessarily be unitary, but may include component parts that are combined to form a flat blade with the guide slot extending around peripheral edges thereof. In any case, the bar 120 may include at least two general portions, namely an exposed portion and a chainsaw body engagement portion. The exposed portion may include the portion of the bar 120 that exposes cutters for use in cutting lumber. Meanwhile, the chainsaw body engagement portion may be the portion of the bar 120 that is hidden by a drive sprocket cover 130 or a clutch cover of the chainsaw 100 when the bar 120 and chain 110 are operably coupled to a main body portion of the chainsaw 100. In some embodiments, the chainsaw body engagement portion may further include a slot disposed to extent substantially along a longitudinal centerline of a portion of the chainsaw body engagement portion. The slot may provide a variable engagement position between the main body portion of the chainsaw 100 and the bar 120. In this regard, one or more tensioner engagement orifices may be disposed proximate to the slot so that one or more pins may engage the tensioner engagement orifices to enable the position of the bar 120 to be changed to adjust the tension of the chain 110.

The drive sprocket may be hidden from view on the chainsaw 100 by the drive sprocket cover 130 (or clutch cover in embodiments where the drive sprocket is embodied as a clutch). The drive sprocket cover 130 may cover over the chainsaw body engagement portion of the bar 120. In other words, the drive sprocket cover 130 may cover over all portions of the bar 120 other than the exposed portion. In an example embodiment, the exposed portion may be considered to be the portion of the bar 120 that is forward of the drive sprocket cover 130 or not covered by the drive sprocket cover 130 when the bar 120 is installed on the chainsaw 100 and the drive sprocket cover 130 is also installed.

In some embodiments, the drive sprocket cover 130 may include a chain tensioner 140 disposed thereon to enable the bar to be shifted forward (as shown by arrow 150) or backward (as shown by arrow 160) to adjust the tension of the chain 110 on the bar 120. The bar 120 may be disposed proximate to a main body portion of the chainsaw 100 such that the chainsaw body engagement portion is proximate to the chainsaw 100 while the exposed portion extends away from the chainsaw 100. The main body portion of the chainsaw 100 may include one or more guide posts extending therefrom inline with each other. The guide posts may be aligned to enable the slot to be fitted over the guide posts. One or more pins that are operably coupled to the chain tensioner 140 may then engage one or more of the tensioner engagement orifices when the drive sprocket cover 130 is installed as shown in FIG. 1. Movement of the chain tensioner 140 in one direction may cause the one or more pins to move forward or rearward to shift the bar 120 forward or backward as shown by arrows 150 and 160, respectively. Movement of the chain tensioner 140 in the other direction, may cause movement of the bar 120 in the opposite direction. The drive sprocket cover 130 may also include a knob 170 that may be tightened to affix or clamp the bar 120 to the main body portion of the chainsaw 100. Moreover, in some cases, the knob 170 may be tightened to also affix the drive sprocket cover 130 to the main body portion of the chainsaw 100. Of course, the knob 170 may be loosened to enable the drive sprocket cover 130 to be removed or to unclamp the bar 120. As will be discussed in greater detail below, the knob 170 may employ a feedback mechanism of an example embodiment in order to provide feedback relative to when the bar 120 is clamped to at least a predefined threshold and potentially further to within a predefined range.

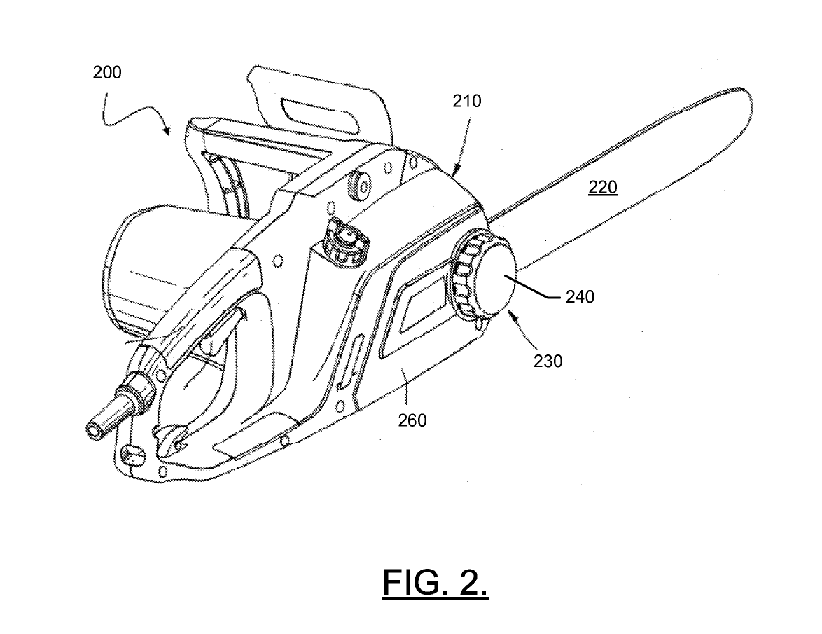

Although chain tensioning and bar clamping may be performed by separate operators in some cases (as in the example of FIG. 1), it should be appreciated that chain tensioning and bar clamping may be performed using a single operator or knob in some cases. An example embodiment will now be described in connection with a structure that employs both chain tensioning and bar clamping using a single knob. However, as indicated above, it should be appreciated that the bar clamping aspects, and the feedback mechanism associated therewith, may be implemented in different ways. Thus, some embodiments may employ a slightly different structure than that which is specifically described in FIG. 2 and therefore FIG. 2 should be appreciated as depicting a non-limiting example.

FIG. 2 shows a chainsaw 200 having a body portion 210 housing a motor (not shown), which motor is preferably an electric motor or an internal combustion engine. A guide bar 220 is attached to the body portion 210 by a tension and clamping assembly 230, at least a portion of which is obscured by a knob sub assembly 240 in FIG. 2. The tension and clamping assembly 230 is provided at one end of the guide bar 220 to both enable the chain to be tensioned and the guide bar 220 to be clamped to the body portion 210 via a single structure. A saw chain is supported in a peripheral groove (not shown) which extends around the guide bar 220, and is in drivable engagement with a sprocket drive wheel fixed to a sprocket drive shaft drivably connected to the motor.

In use, the guide bar 220 may be clamped against an internal clamping surface of the body portion 210 by the tension and clamping assembly 230 (as shown in FIG. 2), which also secures a drive sprocket cover 260 to the body portion 210. The tension and clamping assembly 230 of an example embodiment provides a single mechanism or device (e.g., a knob of a cover assembly) to be used to tension a chainsaw chain, and also to clamp the chainsaw bar. Thus, for example, the same motion (e.g., rotation of the knob sub assembly 240) may be used over a multimodal operation that accomplishes both chain tensioning to a predetermined level and a predetermined amount of bar clamping. Some example embodiments may provide for a mode shift mechanism that is in a first position responsive to operation of the knob sub assembly 240 in the chain tensioning mode until the chain tension reaches the predetermined level, at which time the mode shift mechanism may shift to a second position. Responsive to the shifting of the mode shift mechanism to the second position, the operation of the knob sub assembly 240 may cause bar clamping to the predetermined amount. After chain tightening to the predetermined level is achieved, no further tightening of the chain may be accomplished by operation of the knob. Instead, further operation of the knob sub assembly 240 may cause actions associated with a different mode of operation, namely bar clamping. In this regard, pressure may be exerted on the guide bar 220 in order to clamp the guide bar 220 tightly to the chainsaw body portion 210 until the predetermined amount of pressure is achieved. After the guide bar 220 is clamped to the predetermined amount of pressure, further operation of the knob sub assembly 240 may not increase the bar clamping pressure. However, some embodiments may employ a locking mechanism that may be engaged after bar clamping, to maintain bar tension during operation.

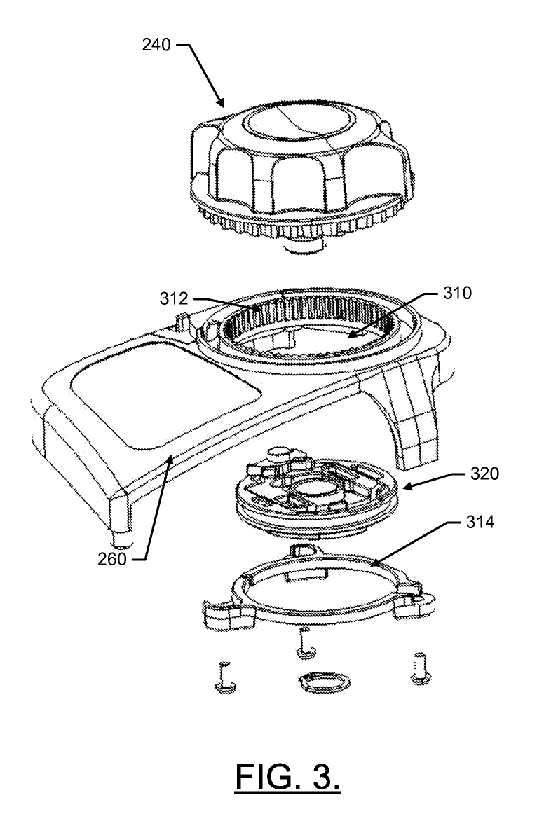

FIG. 3 illustrates a perspective view of a combination tension and clamping assembly 230, which includes the knob sub assembly 240 that is withdrawn from the drive sprocket cover 260 (e.g., a clutch cover) of a chainsaw according to an example embodiment. The tension and clamping assembly 230 may fit within an assembly receiver 310 disposed within the drive sprocket cover 260. The assembly receiver 310 may include gear teeth 312 disposed around an internal periphery thereof and the tension and clamping assembly 230 may be captured into the assembly receiver 310 via a split ring retainer 314 disposed in the drive sprocket cover 260. In some cases, the tension and clamping assembly 230 may be affixed to the assembly receiver 310 via screws or other fixing means. A spiral wheel sub assembly 320 may also be provided to fit within the assembly receiver 310 in order to provide chain tensioning functionality along with the mode shift functionality to enable the tension and clamping assembly 230 to shift between chain tensioning and bar clamping modes of operation.

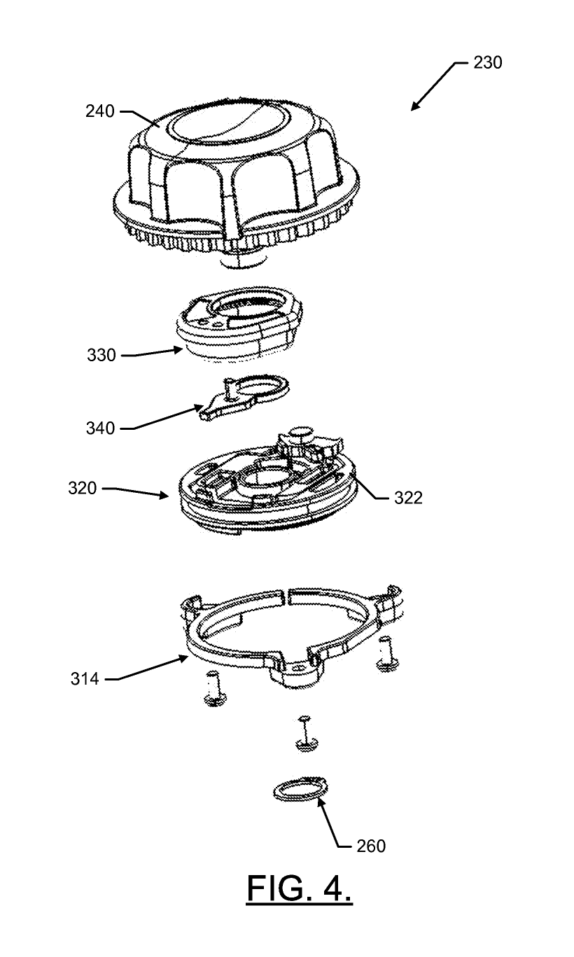

FIG. 4 illustrates an exploded perspective view of some portions of the tension and clamping assembly 230 according to an example embodiment. In this regard, FIG. 4 illustrates the knob sub assembly 240, a cam sub assembly 330, a ratchet selector 340, a retaining ring 350 and the spiral wheel sub assembly 320, which includes a spiral wheel 322. When assembled to form the tension and clamping assembly 230, the spiral wheel sub assembly 320 may be disposed at an exposed end of the tension and clamping assembly 230 to facilitate engagement with the drive sprocket cover 260 (and the assembly receiver 310). The cam sub assembly 330 may include ratcheting functionality in a direction selectable via the ratchet selector 340 for use in the chain tensioning mode in cooperation with operation of the spiral wheel sub assembly 320.

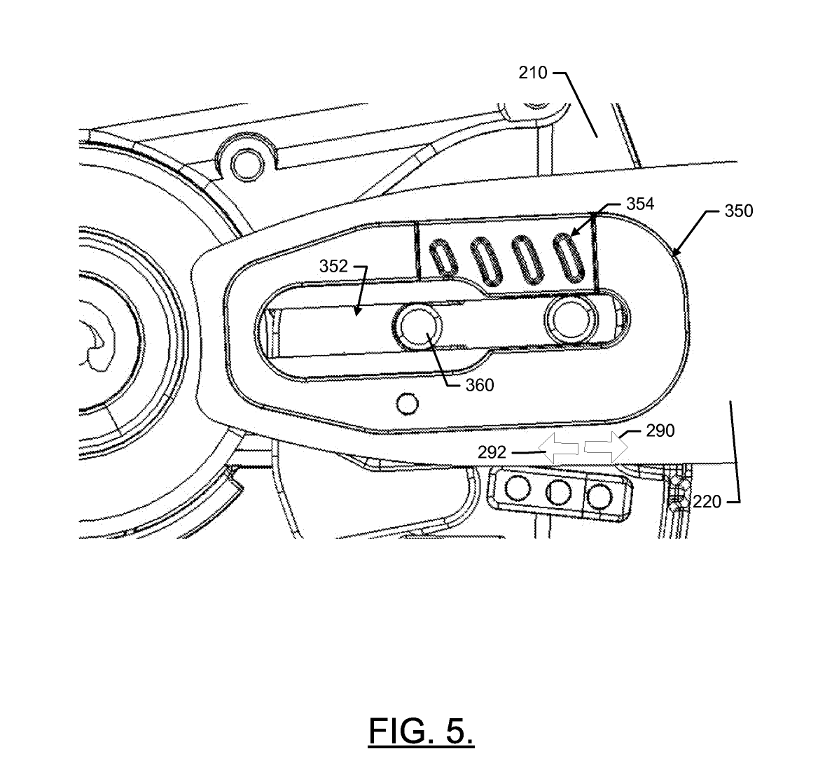

FIG. 5 illustrates a side view of the body portion 210 with drive sprocket cover 260 removed. As can be seen in FIG. 5, the guide bar 220 may be disposed proximate to the body portion 210 such that an adapter plate 350 of the guide bar 220 receives a fixing post 360 of the body portion 210. The fixing post 360 may be a threaded bolt that extends out from the body portion 210 in a direction substantially perpendicular to a plane in which the guide bar 220 lies when disposed proximate to the body portion 210. The adapter plate 350 may include a receiving slot 352 that linearly extends substantially parallel to a longitudinal centerline of the guide bar 220. The receiving slot 352 may have a width that is slightly larger than a diameter of the fixing post 360, and may have a length that is sufficient to enable axial movement (as shown by arrows 290 and 292) of the guide bar 220 to allow for chain tension adjustments. In this regard, for example, a chain (not shown) may ride around the periphery of the guide bar 220, and thus the tension of the chain may be increased as the guide bar 220 moves in a first axial direction (shown by arrow 290) and tension of the chain is decreased as the guide bar 220 is moved in a second axial direction (shown by arrow 292).

The drive sprocket cover 260, with the tension and clamping assembly 230 installed therein, may be placed over the body portion 210 proximate to the guide bar 220 such that the knob sub assembly 240 engages the fixing post 360. The spiral wheel sub assembly 320 may then engage the adapter plate 350 to facilitate chain tension adjustment. In this regard, for example, the spiral wheel 322 of the spiral wheel sub assembly 320 may include spiral protrusions that are configured to engage protrusions 354 disposed on the adapter plate 350 to enable the guide bar 220 to be positionally adjusted for chain tension adjustments.

As can be seen from FIG. 5, the adapter plate 350 may be affixed to one of the faces of the guide bar 220. However, alternatively, the adapter plate 350 may fit (wholly or partially) within a receiving opening in the guide bar 220 to affix the adapter plate 350 to the guide bar 220. In this regard, for example, the adapter plate 350 may lie in a plane that is substantially parallel with a plane in which the guide bar 220 lies and movement of the adapter plate 350 in either axial direction may cause corresponding movement of the guide bar 220. The protrusions 354 may be spaced apart from each other along a longitudinal axis of the adapter plate 350 and the guide bar 220 extending forward of the receiving slot 352. In an example embodiment, the spiral protrusions of the spiral wheel 322 may face the guide bar 220 when the drive sprocket cover 260 engages the body portion 210. The spiral protrusions may include two or more threads. Each of the threads may extend substantially perpendicularly away from a face of the spiral wheel 322 to define a spiral thread that has a distance from an axial center of the spiral wheel 322 that decreases over a length of the threads from a leading edge to a trailing edge thereof. In an example embodiment, each of the threads may extend over an arc that defines less than 360 degrees. For example, in some cases, two threads may be provided such that each thread defines an arc extending over approximately 180 degrees such that a leading edge of one thread is proximate to a trailing edge of the other thread and spaced apart from each other by about the same distance defined between the protrusions 354. A leading edge of each thread may be closer to an axis of rotation of the spiral wheel 322 than its respective trailing edge. Thus, rotation of the knob sub assembly 240 may cause corresponding rotation of the spiral wheel 322 so that the protrusions 354 engage the spiral protrusions and either increase or decrease the tension on the chain based on movement of the guide bar 220 in either of the directions shown by arrows 290 and 292.

Meanwhile, after chain tension adjustment is complete, the tension and clamping assembly 230 may shift from chain tensioning mode to bar clamping mode and the knob sub assembly 240 may tighten down on the fixing post 360 in the clamping mode. Accordingly, chain tensioning may represent (for some embodiments) a first mode of operation, in which movement of the knob sub assembly 240 may be coupled to the spiral wheel 322 so that the spiral wheel 322 rotates responsive to (and in some cases also proportional to) rotation of the knob sub assembly 240. In the second mode of operation (i.e., the clamping mode), movement of the knob sub assembly 240 may not be translated to the spiral wheel 322. Instead, movement of the knob sub assembly 240 may be converted to a tightening of the drive sprocket cover 260 to the body portion 210 (e.g., responsive to tightening of the knob sub assembly 240 onto the fixing post 360). A shift from the first mode to the second mode may occur responsive to movement of a mode shift mechanism, which may be disposed as part of or proximate to the spiral wheel sub assembly 320.

According to some embodiments, regardless of whether the knob sub assembly 240 is in the second mode of operation, or if a knob sub assembly is provided to have only has a single mode of operation (i.e., bar clamping) as is the case with knob 170 of FIG. 1, bar clamping operation may involve the exertion of force on the chainsaw bar via turning of a knob disposed at a drive sprocket cover to tighten the chainsaw bar to the chainsaw body by threaded engagement of the knob or knob sub assembly to a fixing post. Some example embodiments may further provide a feedback mechanism to inform the operator that a predetermined threshold of clamping force has been applied. Moreover, in some cases, the feedback mechanism may further incorporate a torque limiting feature so that, not only is the operator informed that the predetermined threshold is reached, but the operator is also prevented from providing additional torque after the predetermined threshold is reached.

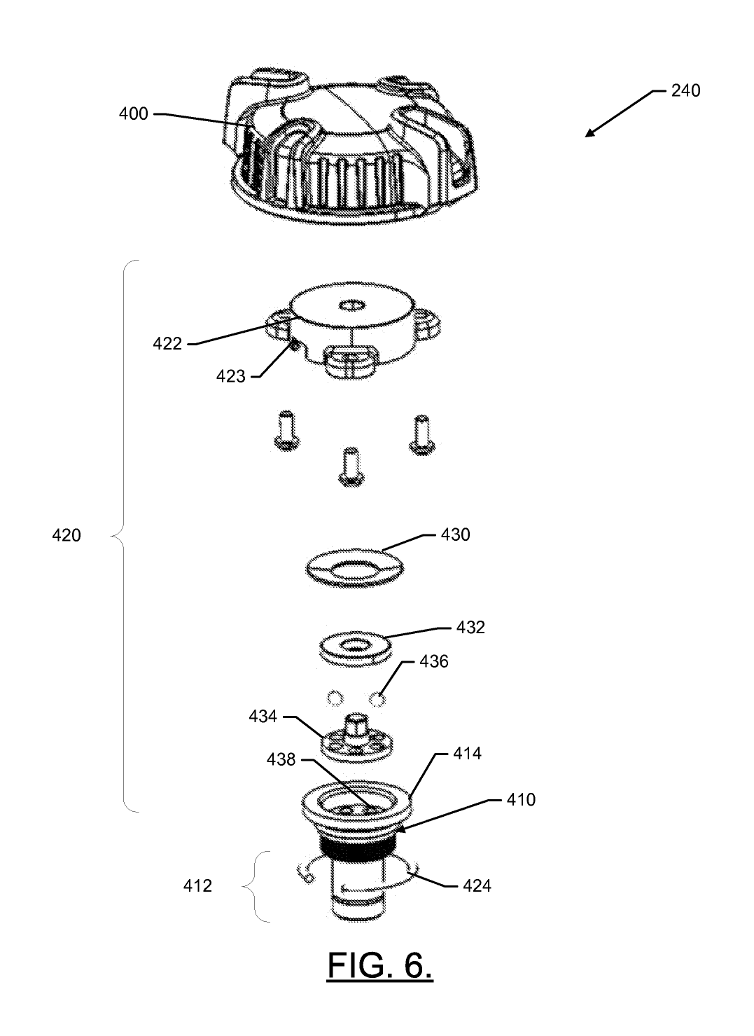

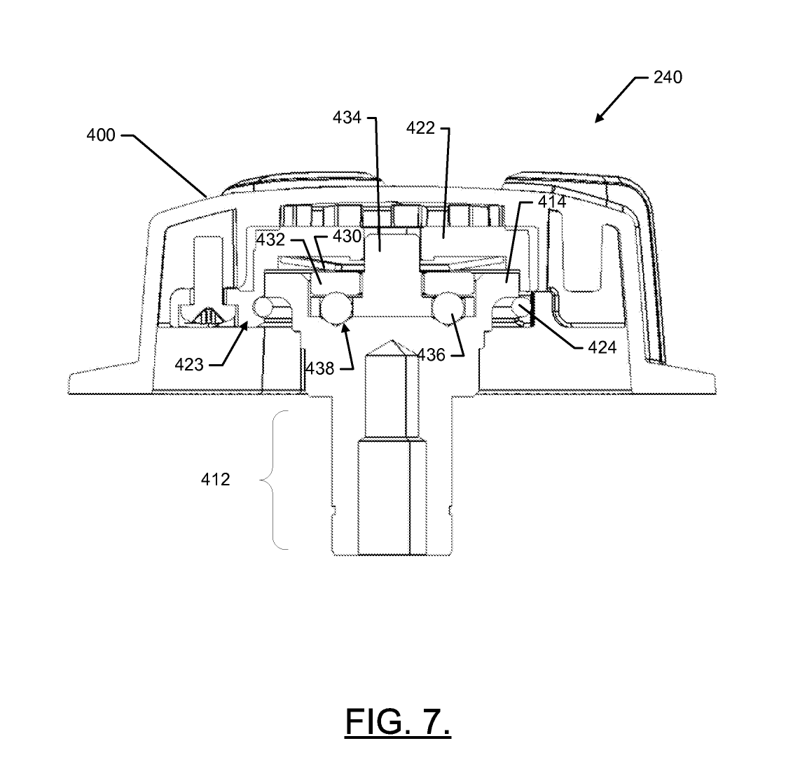

FIGS. 6 and 7 illustrate portions of the knob sub assembly 240 in relation to explaining the operation of the knob sub assembly 240 for provision of feedback according to an example embodiment. It should be appreciated that although feedback provision will be described in the context of the knob sub assembly 240 of FIGS. 2-5, the same feedback mechanisms could be employed in connection with the knob 170 of FIG. 1.

Referring now to FIGS. 6 and 7, FIG. 6 is an exploded view of the knob sub assembly 240 according to an example embodiment and FIG. 7 is a cross sectional view of the knob sub assembly 240 according to an example embodiment. As shown in FIGS. 6 and 7, the knob sub assembly 240 includes a cap 400 and a nut 410. Of note, the term “cap” is merely used to describe the portion of the knob sub assembly 240 that is engageable by the operator's hand. The cap 400 may be a rounded or disc shaped structure with embossed ribs to provide gripping surfaces around an outer periphery thereof for the operator to grasp when attempting to rotate the cap 400. However, no particular shape should be impliedly associated with the cap 400 based on the term “cap” itself. Instead, the cap 400 could be embodied as any rotatable and graspable implement and may have foldable or protruding arms or the like associated therewith. The nut 410 may have a receiving orifice (not shown) that extends along an axial centerline through a shaft portion 412 thereof. The receiving orifice may be threaded along an internal periphery thereof to mate with threads on the fixing post 360.

In a conventional structure, the cap 400 may be secured in a fixed manner to the nut 410 such that any rotational force exerted on the cap 400 is correspondingly transferred to the nut 410. This may allow the nut 410 to be secured to the fixing post 360 responsive to rotation of the cap 400 in a first direction (e.g., clockwise) and allow the nut 410 to be loosened and/or removed responsive to rotation of the cap 400 in a second direction (e.g., counterclockwise). However, the cap 400 of an example embodiment is coupled to the nut 410 via a feedback assembly 420. The feedback assembly 420 is configured to provide feedback to the operator responsive to torque applied at the cap 400 and being communicated to the nut 410 reaching a predetermined threshold. In this regard, for example, the feedback assembly 420 may be configured to transfer torque applied at the cap 400 to the nut 410 until the predetermined threshold is reached, at which time the feedback mechanism 420 may provide feedback to the operator to inform the operator that the predetermined threshold has been reached. The feedback provided by the feedback mechanism 420 may be haptic, audible, or a combination thereof. In some embodiments, in addition to providing feedback to the operator to inform the operator that the predetermined threshold has been reached, the feedback assembly 420 may be further configured to selectively decouple torque transfer from the cap 400 to the nut 410 at or near the predetermined threshold. In other words, the predetermined threshold may act as a breakout torque, which when reached causes the cap 400 to rotate without transferring further torque to the nut 410.

In an example embodiment, the feedback assembly 420 may be operably coupled to both the cap 400 and the nut 410 such that torque transfer may be selectively decoupled. To accomplish the operable coupling, the feedback assembly 420 of some embodiments may include a cup insert 422 and a retaining ring 424. The cup insert 422 may fit within the cap 400 and may be affixed to the cap via snap fitting, screws, bolts, rivets and/or the like. Thus, in some embodiments, the cut insert 422 may be rigidly fixed to the cap 400. However, the cup insert 422 may be flexibly connected to the nut 410. In this regard, for example, the retaining ring 424 may be configured to fit over the shaft portion 412 of the nut 410, but may not be able to fit past a retaining lip 414 of the nut 410. Meanwhile, the retaining ring 424 may snap fit into a retaining groove 423 of the cup insert 422 such that the retaining ring 424 is locked into position relative to the cup insert 422 while holding the retaining lip 414 of the nut 410 between the retaining ring 424 and the cup insert 422. The retaining ring 424 may, however, enable the cup insert 422 to slide relative to the nut 410 when the predetermined threshold is reached.

In an example embodiment, a series of components of the feedback assembly 420 may be provided between the cup insert 422 and the nut 410 to provide the feedback functionality described above. In some cases, these same components (or at least some of them) may also contribute to the selective decoupling capability provided by the feedback assembly 420. In some embodiments, the series of components may include a spring 430, a pressure plate 432, a drive plate 434 and balls 436. The balls 436 may be disposed to fit within receiving holes located in the drive plate 434. A portion of the balls 436 may also sit within depressions 438 disposed on a face of the nut 410 that is disposed at a distal end of the nut 410 relative to the shaft portion 412. The depressions 438 may further be disposed within a receiving space defined at least in part within the peripheral limits defined by the retaining lip 414.

In an example embodiment, an opposite end of the balls 436 to that which sits in the depressions 438 may contact the pressure plate 432, while a majority portion of each of the balls 436 is disposed within the receiving holes of the drive plate 434. The spring 430 (e.g., a disc spring) may be configured to exert a force on the pressure plate 432 to hold the balls 436 in their corresponding depressions 438 until the predetermined threshold of force is reached. Thus, for example, responsive to operator rotation of the cap 400, the torque generated responsive to the rotation is transferred from the cap 400 directly to the cup insert 422. Prior to reaching the predetermined threshold, the spring force of the spring 430 may push against the pressure plate 432 with sufficient force to hold the balls 436 in their respective depressions 438 so that the torque is likewise transferred through the drive plate 434 (which may be fixed relative to the cup insert 422) to the balls 436 and on to the nut 410. Accordingly, the nut 410 will turn with the cap 400.

When the predetermined threshold is reached, the torque applied to the balls 436 may be sufficient to overcome the spring force of the spring 430. Accordingly, each of the balls 436 may roll out of their respective depressions 438 and roll across the face of the nut 410 that is disposed at a distal end of the nut 410 relative to the shaft portion 412 until the next corresponding depression 438 is reached. If torque continues to be applied after the predetermined threshold, then the balls 436 will continue to move to subsequent next depressions 438 until rotation of the cap 400 stops. The movement of the balls 436 may create either or both of an audible and a haptic feedback response to notify the operator that the predetermined threshold has been reached. The depth of depressions 438 may determine how difficult (and therefore the predetermined threshold of torque) it will be to cause the balls 436 to slip or rotate out of one set of depressions 438 and into the next position.

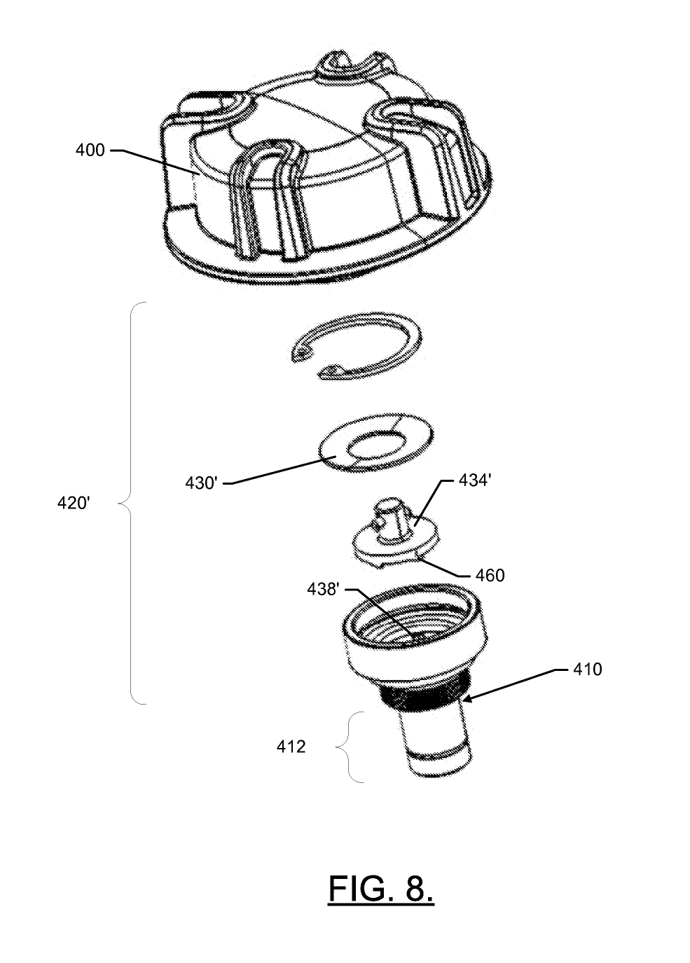

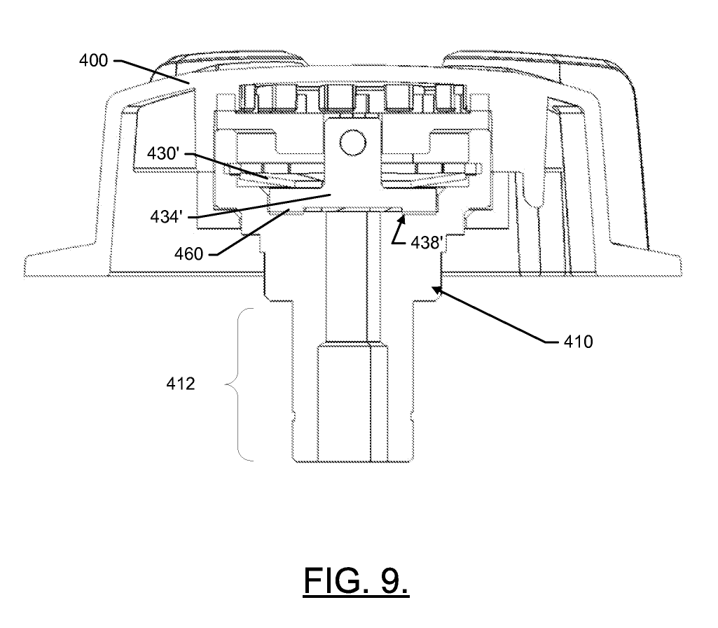

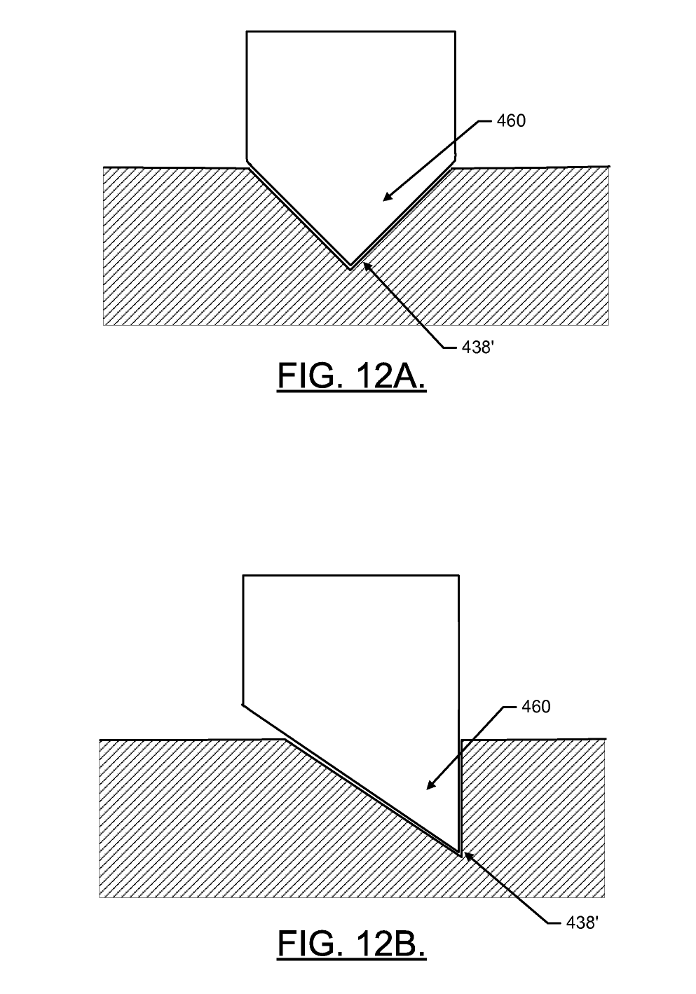

Although the depressions 438 may be used in combination with the drive plate 434, balls 436, spring 430 and pressure plate 432 to selectively couple torque and provide feedback as described above, the feedback assembly 420 may comprise alternative structures in some other embodiments. For example, in some embodiments, the function of the balls 436, drive plate 434 and depressions 438 may be performed by alternative structures. In this regard, for example, some embodiments may selectively couple torque and provide feedback using an inclined ramp assembly. FIG. 8 illustrates an exploded perspective view of a feedback assembly 420′ that employs such an inclined ramp assembly and FIG. 9 shows a cross section view of such a device. In the example of FIG. 8, one or more inclined ramps 460 may be provided on the drive plate 434′ so that the inclined ramps 460 may fit within respective ones of depressions 438′ disposed at the distal end of the nut 410. In such an example, the angle of the incline (along with spring force provided by the spring 430′) may determine the amount of torque required to break the inclined ramps 460 out of their respective depressions 438′ and into a corresponding next one of the depressions 438′. For example, the holding power (R) of the inclined ramps 460 may be equal to P tan α; for friction coefficient, F, at contact surface R=P (tan α+F). Moreover, in some cases, the inclined ramps 460 may be provided with two ramps facing opposite directions so that the selective coupling and feedback functionality may be provided with respect to turning in either the tightening or loosening direction (see FIG. 12A). However, the slopes of the opposing inclined faces may be selected so that desirable applied torque requirements are provided to selectively decouple the cap 400 in each respective direction. It may be desirable, in some cases, to provide a higher value of torque requirement prior to slippage in the loosening direction to ensure that the mechanism can be removed from the chainsaw. The inclined ramps 460 may have an angle parallel with the axis of rotation on one face so that the clutch only works in one direction and is locked in the other to prevent clutch slippage when removing the cover (see FIG. 12B).

In some embodiments, it may be appreciated that surfaces may wear over time. Thus, for example, the breakout torque may not necessarily be a predetermined threshold that is rigidly fixed over time. Instead, the components may be engineered to define tolerances based on expected wear characteristics to define a range of torques that will define the breakout torque over the life of the device. Furthermore, in some embodiments, the cap 400 or another portion of the knob sub assembly 240 may employ a locking mechanism to prevent or at least inhibit loosening of the torque clamping the guide bar 220. In this regard, for example, vibration may cause the threads of the nut 410 to slightly back off the fixing post 360. Thus, some embodiments may employ a lever, a lock, teeth, or other engagement mechanisms in order to engage a portion of the knob sub assembly 240 after the predetermined threshold has been reached so that the corresponding amount of torque continues to be applied for clamping purposes over time.

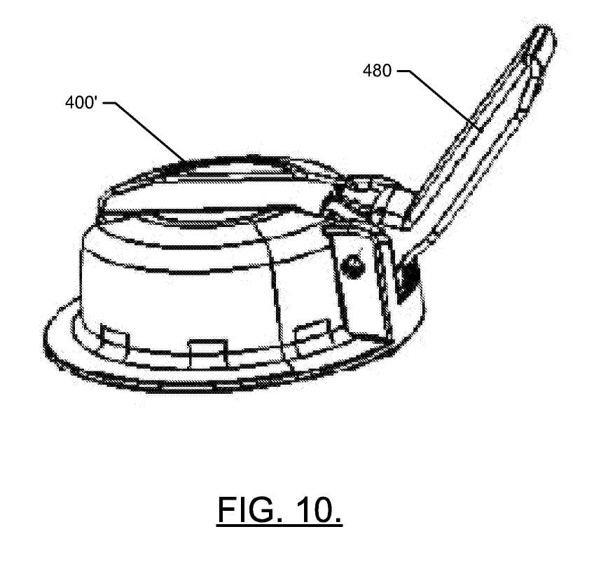

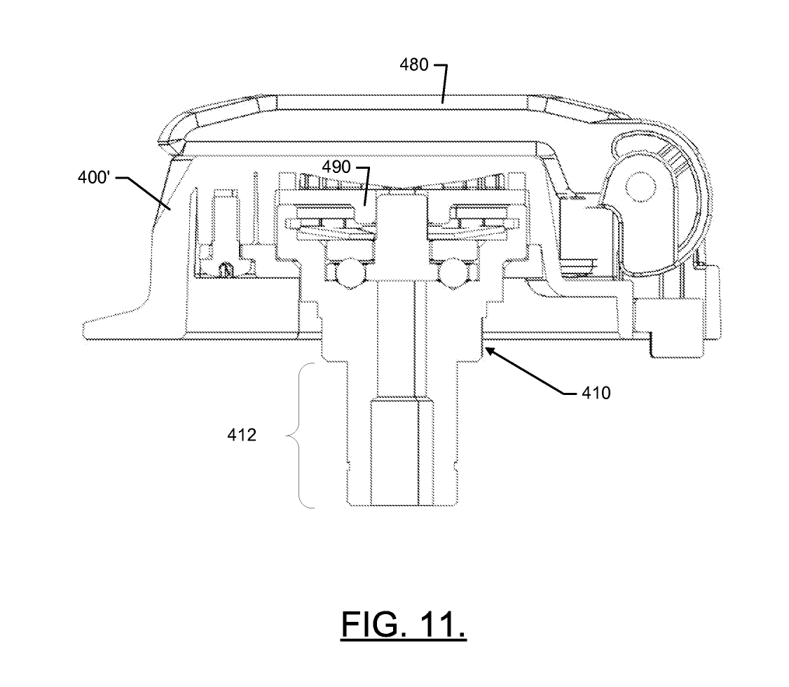

FIG. 10 illustrates a top perspective view of a cap 400′ that employs a locking lever 480 according to an example embodiment. FIG. 11 illustrates a cross sectional view of a knob sub assembly employing the locking lever 480 according to an example embodiment. When the locking lever 480 is in an unlocked state (as shown in FIG. 10), the locking lever 480 may be rotated away from being in contact with or proximate to the cap 400′ along a substantial portion of its longitudinal length. However, when the locking lever 480 is in a locked state (as shown in FIG. 11), cam surfaces on the locking lever 480 may engage a portion of the cap 400′ to draw the cap 400′ closer to the shaft 412 and may cause the cap 400′ to engage a locking ring 490 disposed proximate to the spring and pressure plate to lock the pressure applied thereto and therefore also prevent slippage of the cap 400′ off the nut 410 during operation.

Accordingly, some example embodiments may provide a feedback mechanism within a bar clamping device of a chainsaw. Moreover, the feedback mechanism may not only provide feedback when a predetermined threshold of bar clamping torque is reached, but the feedback mechanism may also prevent further torque from being applied once the predetermined threshold has been reached. Although not required, in some embodiments a chain tensioning mechanism may be provided in combination with a bar clamping mechanism using a single knob that employs the feedback mechanism. For example, a tension and clamping sub assembly may be provided that is disposed at a portion of a drive sprocket cover to enable both adjustment of chain tension in a first mode of operation and clamping of the chainsaw bar in a second mode of operation. The tension and clamping sub assembly may include a mode shift mechanism configured to move between the first and second modes of operation and may also include the feedback mechanism, which may operate only with respect to the second mode of operation. In an example embodiment, the knob may rotate to adjust an axial position of the chainsaw bar to adjust chain tension in the first mode, and may rotate to draw the knob closer to the chainsaw body to adjust bar clamp tension in the second mode. In some embodiments, the second mode may provide selective decoupling of the knob to a nut that draws the knob closer to the chainsaw body prior to reaching a predetermined threshold of torque. In other words, adjustment of bar clamping tension may be configured to stop at a pre-programmed pressure or torque setting. For example, the knob may include a cap and a hub operably coupled to each other such that the hub turns responsive to movement of the cap until a breakaway torque is reached relative to clamping of the chainsaw bar. The hub may no longer turn responsive to movement of the cap after the breakaway torque is reached.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A knob sub assembly for adjusting bar clamp tension holding a chainsaw bar to a chainsaw body, the knob sub assembly comprising:
a cap;
a nut that is threaded to facilitate engagement with a fixing post of the chainsaw body responsive to a transfer of torque from the cap to the nut when the cap is rotated by an operator, wherein the knob sub assembly shifts between chain tensioning and bar clamping modes of operation; and
a feedback assembly disposed substantially between the cap and the nut to at least selectively transfer torque from the cap to the nut, the feedback assembly providing feedback to the operator when a predetermined threshold of applied torque is reached.

2. The knob sub assembly of claim 1, wherein the feedback assembly selectively decouples the transfer of torque from the cap to the nut responsive to the predetermined threshold being reached.

3. The knob sub assembly of claim 2, wherein the feedback assembly comprises a spring configured to exert a force that is overcome to selectively decouple the transfer of torque from the cap to the nut responsive to the predetermined threshold being reached.

4. The knob sub assembly of claim 1, wherein the knob sub assembly rotates to adjust an axial position of the chainsaw bar to adjust chain tension in the chain tensioning mode, and rotates to draw the knob sub assembly closer to the chainsaw body to adjust bar clamp tension in the bar clamping mode.

5. The knob sub assembly of claim 4, wherein the feedback assembly only operates to provide feedback during operation in the bar clamping mode.

6. The knob sub assembly of claim 1, wherein the feedback assembly comprises:
at least one ball held in contact with one of a plurality of depressions disposed at a surface of the nut; and
a spring configured to exert a spring force on the at least one ball to keep the at least one ball fixed in a first depression, the spring force being overcome responsive to the predetermined threshold being reached such that the at least one ball moves from the first depression to a second depression to selectively decouple transfer of torque between the cap and the nut when the spring force is overcome.

7. The knob sub assembly of claim 6, wherein movement of the at least one ball generates the feedback.

8. The knob sub assembly of claim 1, wherein the feedback assembly comprises:
a drive plate having at least one inclined ramp disposed on a surface thereof, the at least one inclined ramp being capable of contacting a corresponding one of a plurality of depressions disposed at a surface of the nut; and
a spring configured to exert a spring force on the drive plate to keep the at least one inclined ramp fixed in a first depression, the spring force being overcome responsive to the predetermined threshold being reached such that the at least one inclined ramp moves from the first depression to a second depression to selectively decouple transfer of torque between the cap and the nut when the spring force is overcome.

9. The knob sub assembly of claim 6, wherein the drive plate comprises adjacent inclined ramps oriented in opposite directions, the adjacent inclined ramps having different slopes.

10. The knob sub assembly of claim 1, wherein the nut comprises:
a shaft portion having threads for engaging the fixing post; and
a retaining lip disposed proximate to a distal end of the nut relative to the shaft portion,
wherein the cap substantially encloses a cup insert that is affixed to the cap, the cup insert being slidably engaged to the retaining lip via a retaining ring that has a circumference greater than a diameter of the shaft portion, but less than a diameter of the nut at the retaining lip.

11. The knob sub assembly of claim 1, wherein the feedback assembly provides haptic or audible feedback responsive to reaching the predetermined threshold.

12. The knob sub assembly of claim 1, wherein bar clamping and provision of feedback occur without tools.

13. The knob sub assembly of claim 1, wherein the cap further comprises a locking lever.

14. A chainsaw comprising:
a chainsaw body;
a chainsaw bar configured to be operably coupled to a cutting chain; and
a drive sprocket cover disposed proximate to a portion of the chainsaw bar to facilitate clamping the chainsaw bar to the chainsaw body,
wherein the drive sprocket cover is configured to receive a knob assembly, the knob sub assembly comprising:
a cap;
a nut that is threaded to facilitate engagement with a fixing post of the chainsaw body responsive to a transfer of torque from the cap to the nut when the cap is rotated by an operator, wherein the knob sub assembly shifts between chain tensioning and bar clamping modes of operation; and
a feedback assembly disposed substantially between the cap and the nut to at least selectively transfer torque from the cap to the nut, the feedback assembly providing feedback to the operator when a predetermined threshold of applied torque is reached.

15. The chainsaw of claim 14, wherein the feedback assembly selectively decouples the transfer of torque from the cap to the nut responsive to the predetermined threshold being reached.

16. The chainsaw of claim 15, wherein the feedback assembly comprises a spring configured to exert a force that is overcome to selectively decouple the transfer of torque from the cap to the nut responsive to the predetermined threshold being reached.

17. The chainsaw of claim 14, wherein the knob sub assembly rotates to adjust an axial position of the chainsaw bar to adjust chain tension in the chain tensioning mode, and rotates to draw the knob sub assembly closer to the chainsaw body to adjust bar clamp tension in the bar clamping mode.

18. The chainsaw of claim 17, wherein the feedback assembly only operates to provide feedback during operation in the bar clamping mode.

19-26. (canceled)

27. A knob sub assembly for adjusting bar clamp tension holding a chainsaw bar of a chainsaw to a chainsaw body of the chainsaw, the knob sub assembly comprising:
a cap;
a nut that is threaded to facilitate engagement with a fixing post of the chainsaw body responsive to a transfer of torque from the cap to the nut when the cap is rotated by an operator, wherein the knob sub assembly shifts between chain tensioning and bar clamping modes of operation; and
an assembly disposed substantially between the cap and the nut, wherein the assembly selectively decouples a transfer of torque from the cap to the nut responsive to a predetermined threshold of applied torque being reached to prevent over-tightening of the nut.

28. The knob sub assembly of claim 27, wherein the assembly comprises a spring configured to exert a force that is overcome to selectively decouple the transfer of torque from the cap to the nut responsive to the predetermined threshold being reached.

29. (canceled)

30. (canceled)
